(19) United States
(12) Patent Application Publication
(10) Pub. No.: US 2014/0146000 A1
(43) Pub. Date: May 29, 2014

(54) TOUCH SENSING DEVICE AND TOUCHSCREEN DEVICE

(71) Applicant: SAMSUNG ELECTRO-MECHANICS CO., LTD., Suwon (KR)

(72) Inventors: Byeong Hak JO, Suwon (KR); Moon Suk Jeong, Suwon (KR); Tah Joon Park, Suwon (KR)

(73) Assignee: Samsung Electro-Mechanics Co., Ltd., Suwon (KR)

(21) Appl. No.: 13/761,826

(22) Filed: Feb. 7, 2013

(30) Foreign Application Priority Data
Nov. 26, 2012 (KR) 10-2012-0134537

(51) Int. Cl. G06F 3/044

(52) U.S. Cl. CPC G06F 3/044
USPC 345/174

(57) ABSTRACT

There are provided a touch sensing device and a touchscreen device, the touch sensing device including a driving circuit unit sequentially applying a driving signal to a plurality of respective driving electrodes, a sensing circuit unit connected to a plurality of sensing electrodes and measuring changes in capacitance in node capacitors formed by the plurality of driving electrodes and the plurality of sensing electrodes, and a noise removing unit providing a preset reference voltage to a driving electrode to which the driving signal is not applied, among the plurality of driving electrodes.

### CROSS-REFERENCE TO RELATED APPLICATIONS

This application claims the priority of Korean Patent Application No. 10-2012-0134537 filed on Nov. 26, 2012, in the Korean Intellectual Property Office, the disclosure of which is incorporated herein by reference.

### BACKGROUND OF THE INVENTION

1. Field of the Invention

The present invention relates to a touch sensing device capable of removing noise introduced to a driving signal, and a touchscreen device.

2. Description of the Related Art

In general, a touch sensing device such as a touchscreen, a touch pad, or the like, an input means attached to a display apparatus to provide an intuitive input method to a user, has recently been widely used in various electronic devices such as cellular phones, personal digital assistants (PDAs), navigation devices, and the like. Particularly, as the demand for smartphones has recently increased, the use of a touchscreen as a touch sensing device capable of providing various input methods in a limited form factor has correspondingly increased.

Touchscreens used in portable devices may mainly be divided into resistive type touchscreens and capacitive type touchscreens according to a method of sensing a touch input implemented therein. Here, the capacitive type touchscreen has advantages in that it has a relatively long lifespan and various input methods and gestures may be easily used therewith, such that the use thereof has increased. Particularly, capacitive type touchscreens may more easily allow for a multi-touch interface as compared with resistive type touchscreens, such that they are widely used in devices such as smartphones, and the like.

Capacitive type touchscreens include a plurality of electrodes having a predetermined pattern and defining a plurality of nodes in which a capacitance changes are generated by a touch input. In the plurality of nodes distributed on a two-dimensional plane, a self-capacitance or mutual-capacitance change is generated by the touch input. A coordinate of the touch input may be calculated by applying a weighted average method, or the like, to the capacitance change generated in the plurality of nodes. In order to accurately calculate the coordinate of the touch input, a technology capable of accurately sensing the capacitance change generated by the touch input is required. However, in the case in which electrical noise is generated in a wireless communications module, a display apparatus, or the like, a capacitance change may be hindered from being accurately sensed.

Among related art documents, Patent Document 1 relates to a touchscreen device and an apparatus and a method for driving a touch panel, in which a node capacitor is charged with a positive voltage and a negative voltage to remove external noise, but content related to separating a driving electrode to which a driving signal is not applied and a driving circuit unit is not disclosed.

### RELATED ART DOCUMENT

(Patent Document 1) Korean Patent Laid-Open Publication No. 10-2011-0137482 (Dec. 23, 2011)

### SUMMARY OF THE INVENTION

An aspect of the present invention provides a touch sensing device capable of blocking a noise component existing on a panel from being introduced to a driving signal by separating a driving electrode to which the driving signal is not applied, from a driving circuit unit, and a touchscreen device.

According to an aspect of the present invention, there is provided a touch sensing device including: a driving circuit unit sequentially applying a driving signal to a plurality of respective driving electrodes; a sensing circuit unit connected to a plurality of sensing electrodes and measuring changes in capacitance in node capacitors formed by the plurality of driving electrodes and the plurality of sensing electrodes; and a noise removing unit providing a preset reference voltage to a driving electrode to which the driving signal is not applied, among the plurality of driving electrodes.

The noise removing unit may include: at least one operational amplifier outputting the reference voltage; and a switching unit including a plurality of switches individually connecting the operational amplifier and the plurality of driving electrodes.

The operational amplifier may include a non-inverting terminal to which the reference voltage is applied, an inverting terminal receiving the reference voltage from the non-inverting terminal through a virtual short-circuit, and an output terminal connected to the inverting terminal.

A switch connected to a driving electrode to which the driving signal is applied, among the plurality of switches, may be switched off and, a switch connected to the driving electrode to which the driving signal is not applied, among the plurality of switches, may be switched on.

The driving circuit unit may generate the driving signal by applying a driving voltage and a common voltage at different times, and the reference voltage may be equal to one of the common voltage and a ground voltage.

According to another aspect of the present invention, there is provided a touchscreen device including: a panel unit including a plurality of driving electrodes and a plurality of sensing electrodes formed to be insulated from the driving electrodes; a driving circuit unit sequentially applying a driving signal to the plurality of respective driving electrodes; a sensing circuit unit connected to the plurality of sensing electrodes and measuring changes in capacitance in node capacitors formed by the plurality of driving electrodes and the plurality of sensing electrodes; a noise removing unit providing a preset reference voltage to a driving electrode to which the driving signal is not applied, among the plurality of driving electrodes; and a control unit controlling operations of the driving circuit unit, the sensing circuit unit, and the noise removing unit.

The control unit may determine at least one of coordinates of a touch input applied to the panel unit, a gesture motion due to the touch input, and the number of touch inputs, from an output signal of the sensing circuit unit.

The noise removing unit may include: at least one operational amplifier outputting the reference voltage; and a switching unit including a plurality of switches individually connecting the operational amplifier and the plurality of driving electrodes.

The operational amplifier may include a non-inverting terminal to which the reference voltage is applied, an inverting terminal receiving the reference voltage from the non-inverting terminal through a virtual short-circuit, and an output terminal connected to the inverting terminal.

A switch connected to a driving electrode to which the driving signal is applied, among the plurality of switches, may be switched off and, a switch connected to the driving electrode to which the driving signal is not applied, among the plurality of switches, may be switched on.

The driving circuit unit may generate the driving signal by applying a driving voltage and a common voltage at different times, and the reference voltage may be equal to one of the common voltage and a ground voltage.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating the exterior of an electronic device including a touch sensing device according to an embodiment of the present invention;

FIG. 2 is a view illustrating a panel unit capable of being included in the touch sensing device according to the embodiment of the present invention;

FIG. 3 is a cross-sectional view of the panel unit illustrated in FIG. 2;

FIG. 4 is a block diagram of a touchscreen device according to an embodiment of the present invention;

FIG. 5 is a detailed circuit diagram illustrating the touchscreen device of FIG. 4;

FIG. 6 is a view illustrating clock signals for driving a plurality of switch elements;

FIGS. 7A through 7C are graphs showing simulation results of the touchscreen device according to the embodiment of the present invention; and

FIG. 8 is a block diagram of a touch sensing device according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

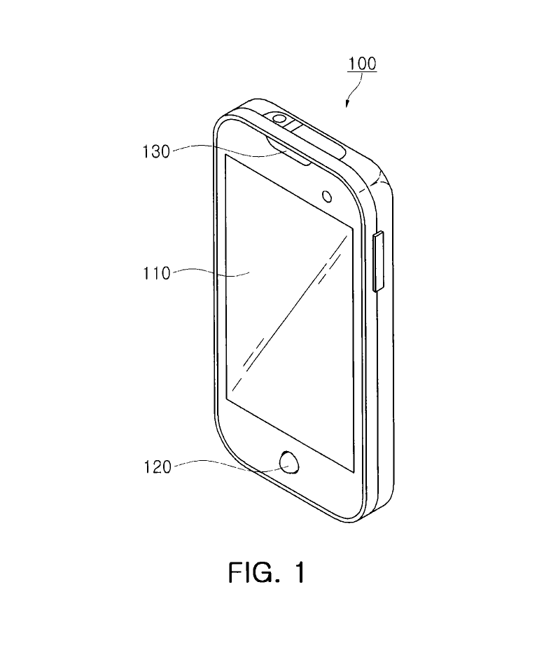

FIG. 1 is a perspective view illustrating the exterior of an electronic device including a touch sensing device according to an embodiment of the present invention.

Referring to FIG. 1, an electronic device 100 according to the present embodiment may include a display device 110 for outputting a screen therethrough, an input unit 120, an audio unit 130 for outputting a sound and the like, and may be integrated with the display device 110 to provide the touch sensing device.

As shown in FIG. 1, in general, a mobile device may be configured in such a manner that a touch sensing device is integrated with a display device, and the touch sensing device may have a high degree of light transmissivity to which an image passes through a screen displayed on the display device. Thus, the touch sensing device may be manufactured by forming a sensing electrode on a base substrate formed of a transparent film material such as polyethylene terephthalate (PET), polycarbonate (PC), polyethersulfone (PES), polyimide (PI) or the like and the sensing electrode is formed of an electrically conductive material such as indium-tin oxide (ITO), indium zinc oxide (IZO), zinc oxide (ZnO), carbon nanotubes (CNT), a conductive polymer, or graphene. A wiring pattern connected to the sensing electrode formed of a transparent conductive material is formed in a bezel region of the display device. Since the wiring pattern is visually shielded by the bezel region, the wiring pattern may also be formed of a metal such as silver (Ag), copper (Cu), or the like.

The touch sensing device according to an embodiment of the present invention may be a capacitive type touch sensing device and accordingly, it may include a plurality of electrodes having a predetermined pattern. Also, the touch sensing device according to an embodiment of the present invention may include a capacitance detection circuit detecting changes in capacitance generated in the plurality of electrodes, an analog-to-digital conversion circuit converting an output signal from the capacitance detection circuit into a digital value, an operation circuit determining a touch input by using data converted as the digital value, and the like.

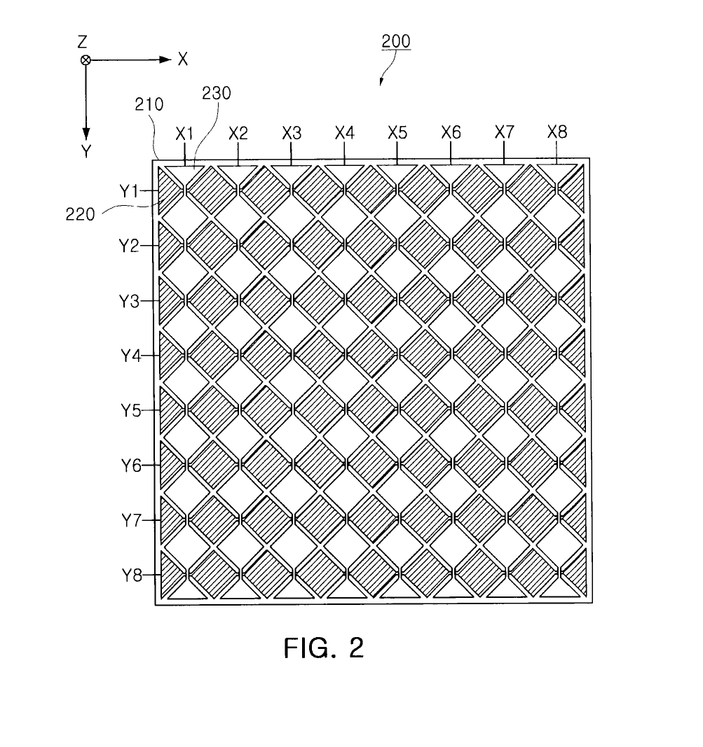

FIG. 2 is a view illustrating a panel unit capable of being included in the touch sensing device according to the embodiment of the present invention.

Referring to FIG. 2, a panel unit 200 according to the present embodiment includes a substrate 210 and a plurality of electrodes 220 and 230 provided on the substrate 210. Although not shown, the plurality of electrodes 220 and 230 may be respectively electrically connected with wiring patterns of a circuit board, which is bonded to one end of the substrate, through wirings and bonding pads. A controller integrated circuit is mounted on the circuit board to detect a sensing signal generated from the plurality of electrodes 220 and 230 and determine a touch input from the sensing signal.

In the case of a touchscreen device, the substrate 210 may be a transparent substrate on which the plurality of electrodes 220 and 230 are formed, and may be formed of a plastic material such as polyimide (PI), polymethylmethacrylate (PMMA), polyethyleneterephthalate (PET), or polycarbonate (PC), or tempered glass. Further, with respect to a region in which the wirings connected to the plurality of electrodes 220 and 230 are formed, except for a region in which the plurality of electrodes 220 and 230 are formed, a predetermined printing region may be formed on the substrate 210 in order to visually shield the wirings which are generally formed of an opaque metal material.

The plurality of electrodes 220 and 230 may be provided on one surface or both surfaces of the substrate 210. The touchscreen device may be formed of indium tin-oxide (ITO), indium zinc-oxide (IZO), zinc oxide (ZnO), carbon nano tube (CNT), a graphene based material, or the like, having transparency and conductivity. In FIG. 2, the plurality of electrodes 220 and 230 having a diamond-like pattern are illustrated, but the present invention is not limited thereto and the electrodes 220 and 230 may have various polygonal patterns such as a rectangular pattern, a triangular pattern, or the like.

The plurality of electrodes 220 and 230 include first electrodes 220 extending in an X-axis direction and second electrodes 230 extending in a Y-axis direction. The first electrodes 220 and the second electrodes 230 may intersect each other on both surfaces of the substrate 210, or on different substrates 210. In the case in which the first electrodes 220 and the second electrodes 230 are all formed on one surface of the substrate 210, predetermined insulating layers may be partially formed in intersections between the first electrodes 220 and the second electrodes 230.

The touch sensing device, electrically connected to the plurality of sensing electrodes 220 and 230 to sense a touch input, may detect changes in capacitance generated from the plurality of electrodes 220 and 230 according to a touch input applied thereto and sense the touch input therefrom. The first electrodes 220 may receive a predetermined driving signal from the controller integrated circuit, and the second electrodes 230 may be used to allow the touch sensing device to detect a sensing signal. Here, the controller integrated circuit may detect, as a sensing signal, changes in mutual-capacitance generated between the first electrodes 220 and the second electrodes 230, and may be operated in such a manner that driving signals are sequentially applied to the respective first electrodes 220 and the changes in capacitance are simultaneously detected by the second electrodes 230. Namely, when M number of first electrodes 220 and N number of second electrodes 230 are provided, the controller integrated circuit may detect data regarding M×N number of changes in capacitance in order to determine a touch input.

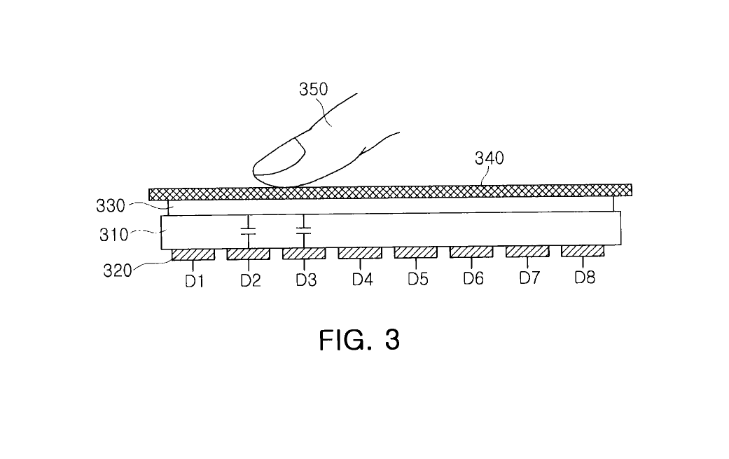

FIG. 3 is a cross-sectional view of the panel unit illustrated in FIG. 2.

FIG. 3 is a cross-sectional view of the panel unit 200 illustrated in FIG. 2, taken along Y-Z plane, and the panel unit 200 may include a substrate 310 and a plurality of sensing electrodes 320 and 330 as described above with reference to FIG. 2 and further include a cover lens 340 receiving contact. The cover lens 340 may be disposed on the second electrode 330 used for detecting a sensing signal and receive a touch input from a contact object 350 such as a finger, or the like.

When driving signals are sequentially applied to the first electrodes 320 through channel D1 to D8, mutual capacitance may be generated between the first electrodes 320 to which the driving signals are applied and the second electrode 330. When the driving signals are sequentially applied to the first electrodes 320, changes in mutual capacitance generated between the first electrodes 320 and the second electrode 330 adjacent to a region with which the contact object 350 is brought into contact may be caused. The changes in capacitance may be proportional to the area of an overlapping region between the contact object 350 and the first electrodes 320 to which the driving signals are applied and the second electrode 330. In FIG. 3, mutual capacitance generated between the first electrodes 320 and the second electrode 330 connected to the channels D2 and D3 is affected by the contact object 350.

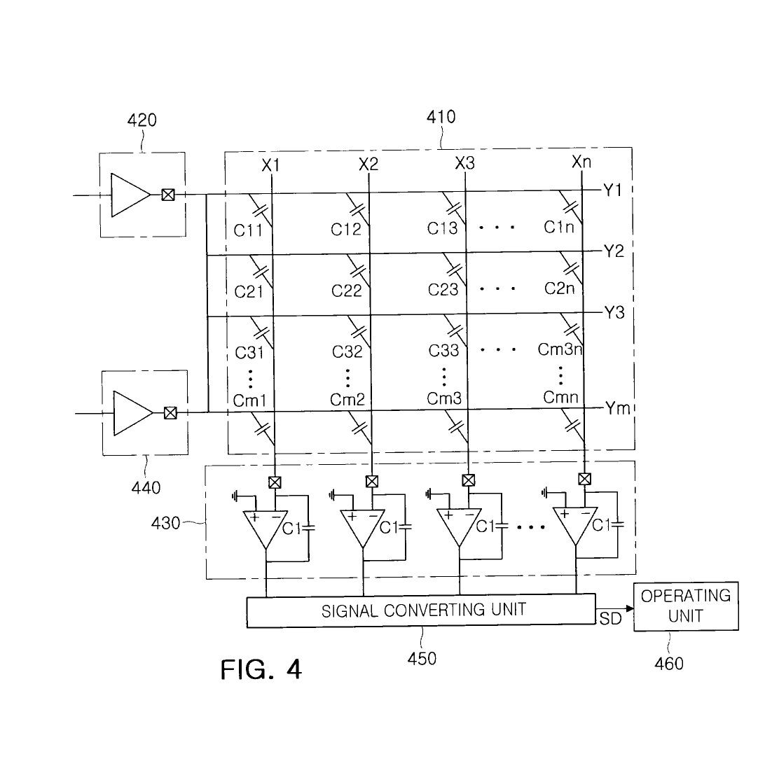

FIG. 4 is a block diagram of a touchscreen device according to an embodiment of the present invention. Referring to FIG. 4, a touchscreen device according to the present embodiment includes a panel unit 410, a driving circuit unit 420, a sensing circuit unit 430, a noise removing unit 440, a signal converting unit 450, and an operating unit 460. The driving circuit unit 420, the sensing circuit unit 430, the noise removing unit 440, the signal converting unit 450, and the operating unit 460 may be implemented as a single integrated circuit (IC).

The panel unit 410 may include m number of first electrodes extended in a first axis direction—that is, a horizontal direction in FIG. 4, and n number of second electrodes extended in a second axis direction that intersect with the first axis direction, that is, a vertical direction in FIG. 4. The changes in capacitance C11 to Cmn generated in a plurality of nodes in which first electrodes and second electrodes intersect with each other may be generated. The changes in capacitance C11 to Cmn generated in the plurality of nodes may be the changes in mutual-capacitance generated by the driving signals applied to the first electrodes from the driving circuit unit 420. Here, the first electrodes to which the driving signals are applied may be referred to driving electrodes.

The driving circuit unit 420 may apply predetermined driving signals to the first electrodes of the panel unit 410. The driving signals may include a square wave signal, a sine wave signal, a triangle wave signal, and the like, which have a predetermined cycle and amplitude, and may be sequentially applied to the plurality of first electrodes. FIG. 4 illustrates that a single circuit for applying a driving signal is connected to the plurality of respective first electrodes. However, alternatively, a plurality of driving circuit may be provided and driving signals may be applied to the respective first electrodes.

Also, the driving signals may be simultaneously applied to all the first electrodes or may be selectively applied to only a portion of the first electrodes to simply detect the presence or absence of a touch input.

The sensing circuit unit 430 may include an integration circuit for sensing the changes in capacitance C11 to Cmn generated in the plurality of nodes. The integration circuit may be connected to the plurality of second electrodes. The integration circuit may include at least one operational amplifier and a capacitor C1 having a predetermined capacitance. An inverting input terminal of the at least one operational amplifier is connected to the second electrodes, and thus, the changes in capacitance C11 to Cmn are converted into an analog signal such as a voltage signal or the like to be output. Here, the second electrodes connected to the sensing circuit unit may be referred to sensing electrodes. When driving signals are sequentially applied to the plurality of respective first electrodes, since changes in capacitance C11 to Cmn may be simultaneously detected from the second electrodes, the integration circuit may be provided in an amount equal to n number of second electrodes.

The noise removing unit 440 may remove a noise component present in a driving signal generated by the driving circuit unit 420. For example, when the driving circuit unit 420 applies a driving signal to an Y1 electrode, a noise component existing on the panel unit 410 may be introduced to the driving circuit unit 420 through a channel connected to the Y2 to Ym electrodes. The noise component introduced to the driving circuit unit 420 may affect the driving signal, and here, the noise removing unit 440 may provide a preset reference voltage to separate the electrodes to which the driving signal is not applied, from the driving circuit unit 420.

The signal converting unit 450 generates a digital signal S_{D} from the analog signal generated by the integration circuit. For example, the signal converting unit 450 may include a time-to-digital converter (TDC) circuit for measuring a period of time for which an analog signal output in the form of voltage from the sensing circuit unit 430 reaches a predetermined reference voltage level and converting the period of time into the digital signal S_{D} or an analog-to-digital converter (ADC) circuit for measuring an amount by which a level of the analog signal output from the sensing circuit unit 430 is changed for a predetermined period of time and converting the amount into the digital signal S_{D}. The operating unit 460 determines a touch input applied to the panel unit 410 by using the digital signal S_{D}. For example, the operating unit 460 may determine the number of touch inputs applied to the panel unit 410, coordinates of the touch input, a gesture based on the touch input, or the like.

The digital signal S_{D} used as a reference for the operating unit 460 to determine a touch input may be data obtained by digitizing the changes in capacitance C11 to Cmn, and in particular, the data may be indicate a difference in capacitance between a case in which a touch input is not generated and a case in which a touch input is generated. In general, in a capacitive type touch sensing device, a region with which a conductive object comes into contact has reduced capacitance as compared to a region to which contact is not applied.

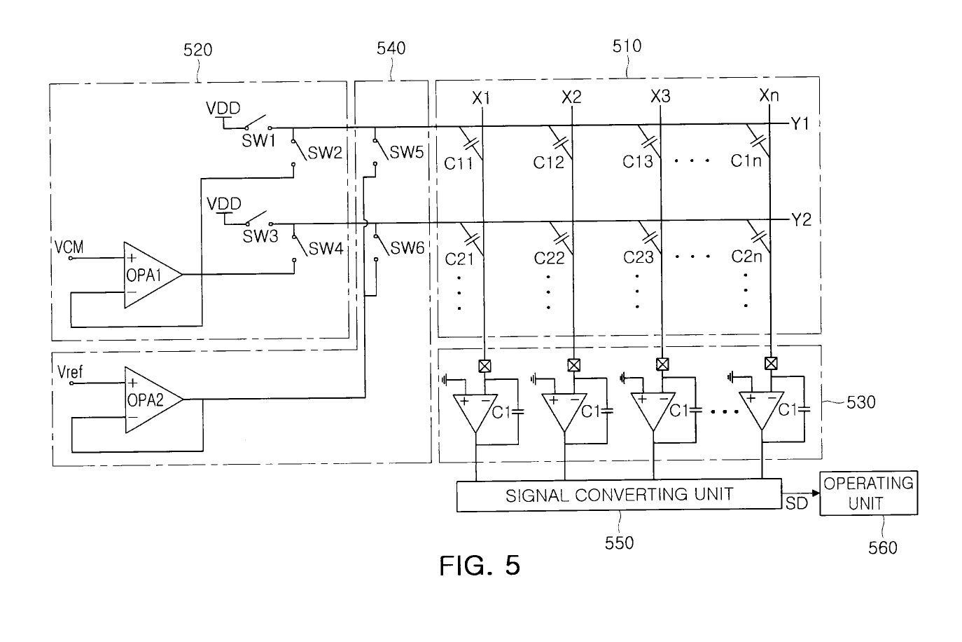

FIG. 5 is a detailed circuit diagram illustrating the touchscreen device of FIG. 4. Unlike the panel unit 410 of FIG. 4, a panel unit 510 of FIG. 5 only includes the first electrodes Y1 and Y2, but it is illustrated schematically for the convenience of description and the panel unit 510 of FIG. 5 is the same as the panel unit 410 of FIG. 4.

A driving circuit unit 520 may include a first operational amplifier OPA1 and a plurality of switches SW1 to SW4 to be connected to the plurality of first electrodes. In detail, the first operational amplifier OPA1 includes a non-inverting terminal receiving a common voltage VCM, an inverting terminal maintaining the same potential as that of the non-inverting terminal, and an output terminal connected to the inverting terminal. The first operational amplifier OPA1 may provide the common voltage VCM to the plurality of respective first electrodes through respective switches connected to the output terminal thereof. The common voltage VCM may be set to have a potential having an intermediate level of that of a driving voltage VDD.

The plurality of respective first electrodes receives the driving voltage VDD and the common voltage VCM through two switches. For example, the Y1 electrode receives the driving voltage VDD and the common voltage VCM through first and second switches SW1 and SW2, and the Y2 electrode receives the driving voltage VDD and the common voltage VCM through third and fourth switches SW3 and SW4.

When a driving signal is applied to the Y1 electrode, the first switch SW1 and the second switch SW2 are turned on and off at different times to generate a driving signal. Here, even in the case in which a driving signal is applied to the Y1 electrode, the common voltage VCM is applied to the Y2 electrode to which the driving signal is not applied, in order to reduce capacitance of a feedback capacitor C1 of a sensing circuit unit 530. In this case, however, as mentioned above, in the case in which a driving signal is applied to the Y1 electrode, when the fourth switch SW4 is turned on to provide the common voltage VCM to the Y2 electrode, a noise component present on the panel unit may be introduced to the first operational amplifier OPA1 through a channel connected to the Y2 electrode, such that the noise component is mixed in the driving signal.

In this case, the noise removing unit 540 provides a preset reference voltage to a first electrode to which the driving signal is not applied among the plurality of first electrodes, in order to remove noise introduced to the first operational amplifier OPA1. The noise removing unit 540 may include a second operational amplifier OPA2 including a non-inverting terminal receiving a reference voltage Vref, an inverting terminal maintaining the same potential as that of the non-inverting terminal, and an output terminal connected to the inverting terminal, and a plurality of switches SW5 and SW6 connecting the plurality of first electrodes and the second operational amplifier OPA2. In FIG. 5, the noise removing unit 540 is illustrated as being connected to Y1 and Y2, portions of the plurality of first electrodes, but it is merely illustrative for the convenience of description and the noise removing unit 540 may be individually connected to the plurality of first electrodes.

The switch connected to the first electrode to which the driving signal is applied, among the plurality of switches included in the noise removing unit 540, may be switched off, and the switch connected to the first electrode to which the driving signal is not applied among the plurality of switches may be switched on. Here, the preset reference voltage may be set to have the same potential level as that of a common voltage or a ground voltage.

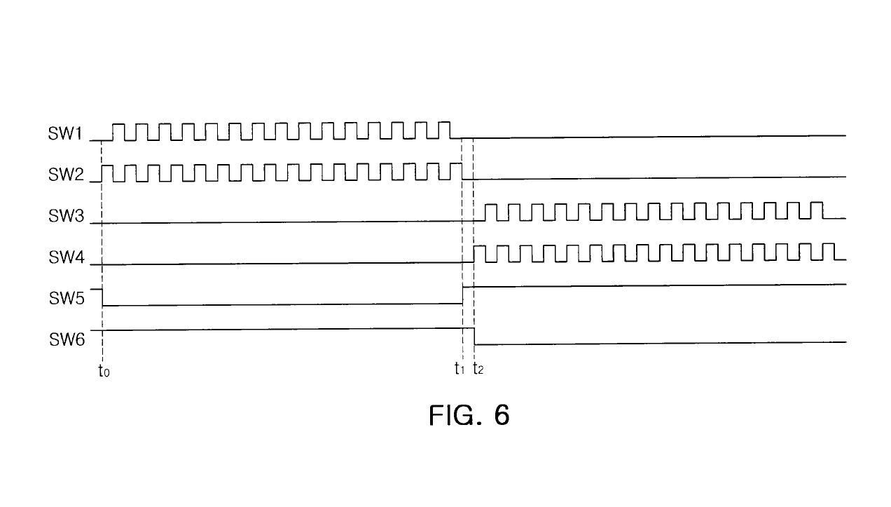

FIG. 6 is a view illustrating clock signals for driving a plurality of switch elements. As illustrated in FIG. 6, when the first switch SW1 and the second switch SW2 are operated by clock signals having the same period but different (high and low) levels in a section from time t₀ to time t₁, a driving signal is applied to the Y1 electrode. Here, the fifth switch SW5 connected to the Y1 electrode to which the driving signal is applied is turned off, and the sixth switch SW6 connected to the Y2 electrode to which a driving signal is not applied is turned on.

Since a driving signal is not applied to any one of the plurality of first electrodes in a section from time t₁ to time t₂, both the fifth and sixth switches SW5 and SW6 are turned on.

After the time t₂, when the third and fourth switches SW3 and SW4 are operated by clock signals in a similar manner as in the section from time t₀ to time t₁, a driving signal is applied to the Y2 electrode and, in this case, the sixth switch SW6 connected to the Y2 electrode to which the driving signal is applied is turned off and the fifth switch SW5 connected to the Y1 electrode to which the driving signal is not applied is turned on.

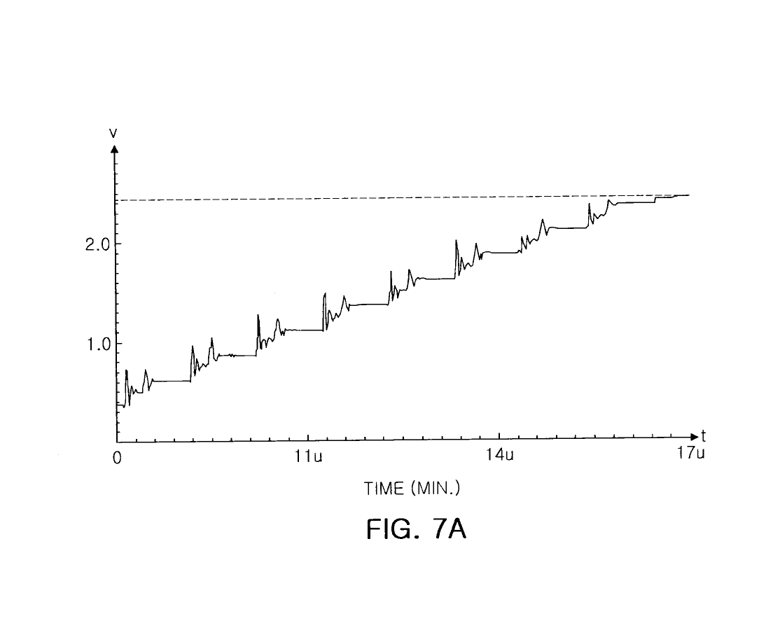

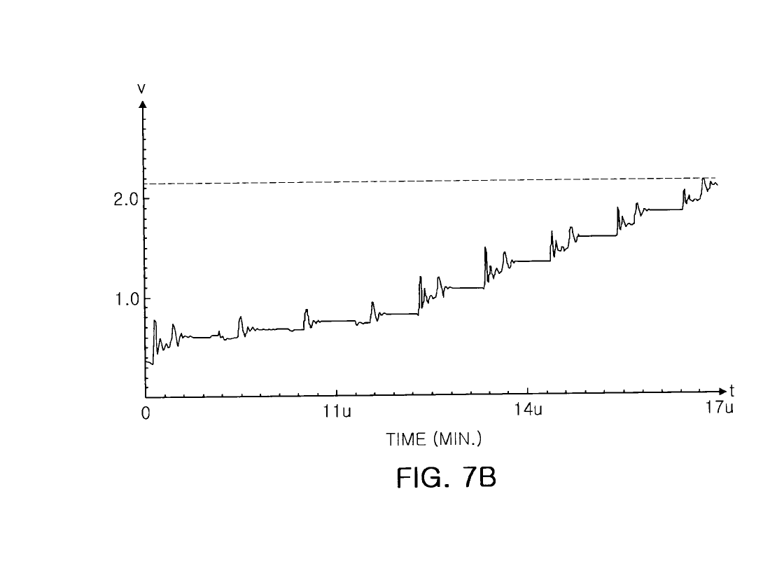

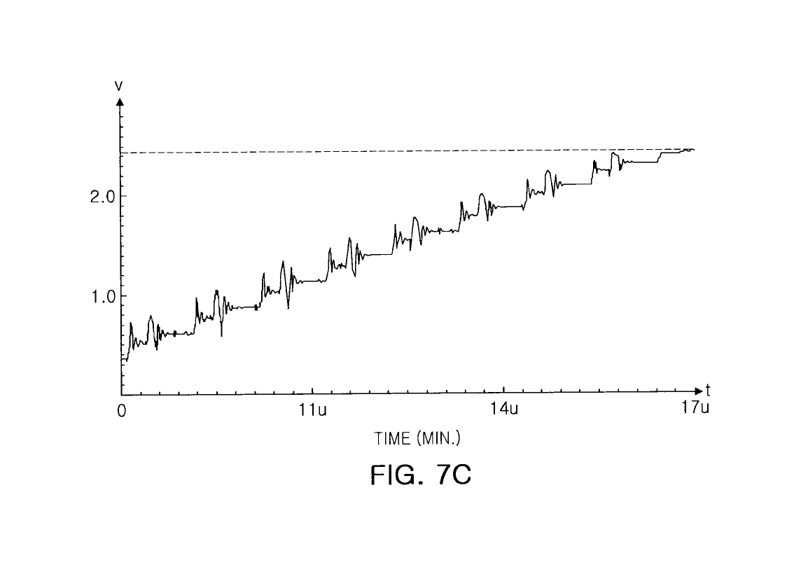

FIGS. 7A through 7C are graphs showing simulation results of the touchscreen device according to the embodiment of the present invention. FIGS. 7A through 7C are graphs showing output voltages of the sensing circuit units 430 and 530 of FIGS. 4 and 5. FIG. 7A is a graph in the case of the presence of noise, and FIGS. 7B and 7C are graphs in the case of absence of noise. Specifically, FIG. 7B is a graph in the case in which the first operational amplifier OPA1 of FIG. 5 provides a common voltage to the first electrode to which a driving signal is not applied, and FIG. 7C is a graph in the case in which the second operational amplifier OPA2 of FIG. 5 provides a common voltage to the first electrode to which a driving signal is not applied.

In FIG. 7A, a final output voltage is approximately 2.4V. In FIG. 7B, a final output voltage is approximately 2.15V. In FIG. 7C, a final output voltage is approximately 2.43V. It can be seen that, unlike FIG. 7B, FIG. 7C has a similar form to that of FIG. 7A, and thus, a noise component has been removed in an embodiment of the present invention.

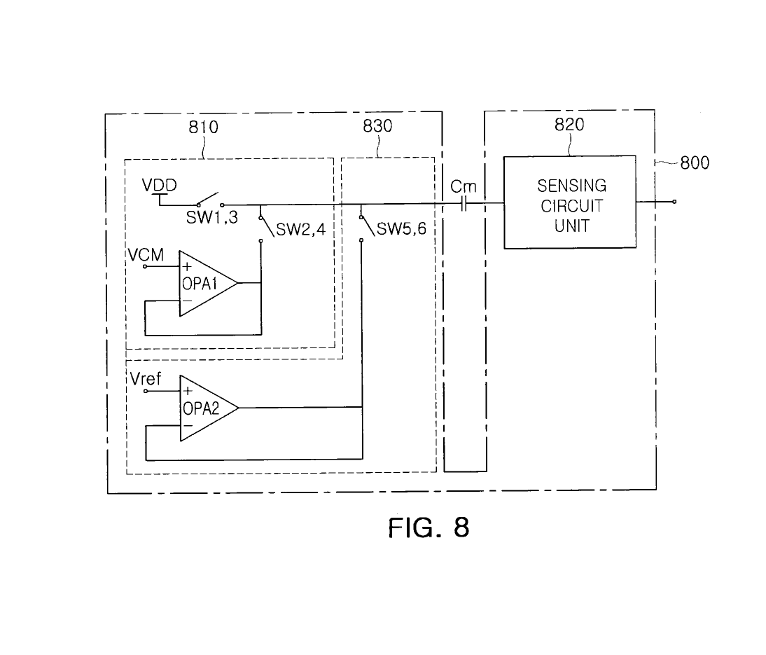

FIG. 8 is a block diagram of a touch sensing device according to an embodiment of the present invention. A touch sensing device 800 according to an embodiment of the present invention may include a driving circuit unit 810, a sensing circuit unit 820, and a noise removing unit 830. In FIG. 8, the capacitor Cm corresponds to the capacitors C11 to Cmn of FIG. 4, which may be assumed to be node capacitors to or from which charges are stored or discharged according to the changes in mutual capacitance generated in the intersections of the plurality of electrodes.

Configurations and operations of the driving circuit unit 810, the sensing circuit unit 820, and the noise removing unit 830 of the touch sensing device 800 are similar to those in the embodiments of FIGS. 4 and 5, so a detailed description thereof will be omitted.

As set forth above, according to the embodiments of the invention, a driving electrode to which a driving signal is not applied is separated from a driving circuit unit, a noise component existing on a panel is prevented from being introduced to a driving signal, thus accurately determining an input touch.

While the present invention has been shown and described in connection with the embodiments, it will be apparent to those skilled in the art that modifications and variations can be made without departing from the spirit and scope of the invention as defined by the appended claims.

What is claimed is:

1. A touch sensing device comprising:
a driving circuit unit sequentially applying a driving signal to a plurality of respective driving electrodes;
a sensing circuit unit connected to a plurality of sensing electrodes and measuring changes in capacitance in node capacitors formed by the plurality of driving electrodes and the plurality of sensing electrodes; and
a noise removing unit providing a preset reference voltage to a driving electrode to which the driving signal is not applied, among the plurality of driving electrodes.

2. The touch sensing device of claim 1, wherein the noise removing unit includes:
at least one operational amplifier outputting the reference voltage; and
a switching unit including a plurality of switches individually connecting the operational amplifier and the plurality of driving electrodes.

3. The touch sensing device of claim 2, wherein the operational amplifier includes a non-inverting terminal to which the reference voltage is applied, an inverting terminal receiving the reference voltage from the non-inverting terminal through a virtual short-circuit, and an output terminal connected to the inverting terminal.

4. The touch sensing device of claim 2, wherein a switch connected to a driving electrode to which the driving signal is applied, among the plurality of switches, is switched off and,
a switch connected to the driving electrode to which the driving signal is not applied, among the plurality of switches, is switched on.

5. The touch sensing device of claim 1, wherein the driving circuit unit generates the driving signal by applying a driving voltage and a common voltage at different times, and
the reference voltage is equal to one of the common voltage and a ground voltage.

6. A touchscreen device comprising:
a panel unit including a plurality of driving electrodes and a plurality of sensing electrodes formed to be insulated from the driving electrodes;
a driving circuit unit sequentially applying a driving signal to the plurality of respective driving electrodes;
a sensing circuit unit connected to the plurality of sensing electrodes and measuring changes in capacitance in node capacitors formed by the plurality of driving electrodes and the plurality of sensing electrodes;
a noise removing unit providing a preset reference voltage to a driving electrode to which the driving signal is not applied, among the plurality of driving electrodes; and
a control unit controlling operations of the driving circuit unit, the sensing circuit unit, and the noise removing unit.

7. The touchscreen device of claim 6, wherein the control unit determines at least one of coordinates of a touch input applied to the panel unit, a gesture motion due to the touch input, and the number of touch inputs, from an output signal of the sensing circuit unit.

8. The touchscreen device of claim 6, wherein the noise removing unit includes:
at least one operational amplifier outputting the reference voltage; and
a switching unit including a plurality of switches individually connecting the operational amplifier and the plurality of driving electrodes.

9. The touchscreen device of claim 8, wherein the operational amplifier includes a non-inverting terminal to which the reference voltage is applied, an inverting terminal receiving the reference voltage from the non-inverting terminal through a virtual short-circuit, and an output terminal connected to the inverting terminal.

10. The touchscreen device of claim 8, wherein a switch connected to a driving electrode to which the driving signal is applied, among the plurality of switches, is switched off and,
a switch connected to the driving electrode to which the driving signal is not applied, among the plurality of switches, is switched on.

11. The touchscreen device of claim 6, wherein the driving circuit unit generates the driving signal by applying a driving voltage and a common voltage at different times, and
the reference voltage is equal to one of the common voltage and a ground voltage.
